(19) United States
(12) Patent Application Publication
(10) Pub. No.: US 2009/0047424 A1
(43) Pub. Date: Feb. 19, 2009

(54) INK RECEPTIVE MATERIAL, TINTED OPTICAL LENSES AND METHOD FOR MANUFACTURING THE SAME

(75) Inventor: Tsukasa Momma, Kanagawa (JP)

Correspondence Address: OCCHIUTI ROHLICEK & TSAO, LLP, 10 FAWCETT STREET, CAMBRIDGE, MA, 02138, US

(73) Assignee: Essilor International/ Nikon-Essilor Co., Ltd., Tokyo (JP)

(21) Appl. No.: 11/814,140

(22) PCT Filed: Jan. 25, 2006
(86) PCT No.: PCT/EP06/01147

§ 371 Date: May 9, 2008

(30) Foreign Application Priority Data
Jan. 25, 2005 (EP) 05290166.7

(51) Int. Cl. B05D 5/04; G02B 1/04; C09C 1/02; C09C 1/28; B05D 5/06; C09D 7/12; C09C 1/36; C09D 101/08

(52) U.S. Cl. 427/162; 523/106; 523/108; 106/400; 106/464; 106/486; 106/469; 106/436; 106/425; 106/419; 106/483; 106/482; 106/505; 106/481; 106/499; 106/501.1

(57) ABSTRACT

The present invention relates to tinted optical lenses and to methods of manufacturing tinted optical lens. This invention relates to a method for tinting optical lenses using an ink receptor film. The method of the invention allows a good transfer of the color to the substrate which represents the support of lens, a good final coloration of the substrate with good color homogeneity. The invention relate also to a method of tinting optical lenses, using the said ink receptor film which is applied onto a primer layer coating the substrate of the lens. The ink receptor material comprises an inorganic filler and an water-based emulsion. Preferably the ink receptor material also comprises a water-soluble polymer, a modified cationic polymer and a carrier able to accelerate the absorption of the ink into the substrate.

The present invention relates to optical lenses and to methods of manufacturing optical lenses. More specifically, the present invention relates to a tinted optical lens and to a method of manufacturing tinted optical lenses.

In the meaning of this invention, the term “lens” means ophthalmic elements fitting for spectacles, eyeglasses, sunglasses, goggles or the like, regardless of whether it performs any correcting function.

Manufacturers have encountered numerous technical challenges when manufacturing tinted lenses. As is known in the prior art, glass lenses are often tinted by introducing colored additives to the molten glass, and similarly polycarbonate lenses are injection-moulded from pre-colored plastic granules. A disadvantage associated with these methods is the very limited flexibility in the range of colors that can be offered. Moreover, lenses with highly varying thickness also exhibit non-uniform transmittance when colored by this method.

Another prior art process consists in dipping hard resin lenses into a hot, liquid dye solution. The dyes enter into the resin, thus resulting in coloring the lens. However, this process makes it difficult to achieve tint uniformity and shows poor color reproducibility.

One proposal in the prior art to overcome some of the problems associated with lens tinting is to apply a material able to receive the tint; such material may be a thin film coated onto an essentially transparent substrate. For example, JP3075403 and JP3349116 describe a method of making a tinted plastic lens, comprising the steps of forming a hardening coating of a water-soluble polymer on the surface of the optical substrate of the lens, applying on said coating an ink aqueous solution containing disperse dyes, by means of an ink jet printer, heat treating, and finally removing, by rinsing, the water-soluble polymer coating.

The Applicant observed that, in the process described in the aforementioned Japanese documents, contacting the water-soluble polymer with the ink solution results in that the ink solution flows downward the curved substrate by gravitation to the centre or to the edges of the substrate, before the ink enters into the water-soluble polymer coating: this method does not allow the application of a large quantity of ink and results in a poor uniformity of tint of the lens. The remaining ink solution is diluted in the water-polymer film, and makes it difficult to obtain high color intensity.

Therefore, there is an actual need in new methods, industrially effective, for tinting optical lenses, which would not have the drawbacks of the prior art systems.

This invention relates to a method for tinting optical lenses, wherein the composition of the ink receptor material allows to a coating, which is a porous film, capable to absorb the color with high speed and in large quantity, to remain stable after absorption of the color and to have a good adhesion to the substrate; the method of the invention allows a good transfer of the color to the substrate which represents the support of lens, a good final coloration of the substrate with a good color homogeneity and with high color intensity when needed and then an acceptable cosmetic tinted lens. In another embodiment of the invention, the method allows a good transfer of the color to a primer layer coating onto the substrate of the lens, and then allows also to an acceptable cosmetic tinted lens.

The invention also relates to said new ink receptor material, to its use for forming a film onto a lens substrate or onto a primer coating the said lens substrate, and to its use for manufacturing tinted lenses.

The new ink receptor material according to the invention comprises an inorganic filler and a water-based emulsion (which contains a water-dispersed polymer, said polymer being non soluble in the water), which have been mixed and form a solution. The ink receptor material of the invention is a solution able to form a porous film, the water-dispersed polymer helping for the adhesion of the film to the substrate. The ink material solution can be applied on a three dimensional surface like a convex or concave surface of an optical lens and forms, after evaporation of the solvents, a porous film on the surface of the substrate.

The presence of the inorganic filler plays an important role in the porosity of the film. The porous film of the invention will allow a capacity phenomenon to occur, when the liquid ink is applied on it, thus enhancing the quantity of ink capable to penetrate into the film.

According to an embodiment of the invention, the inorganic filler may be light calcium carbonate, heavy calcium carbonate, kaolin, talc, titanium dioxide, zinc oxide, zinc carbonate, satin white, magnesium carbonate, magnesium silicate, magnesium sulphate, calcium silicate, aluminium silicate, aluminium hydroxide, alumina sol, colloidal alumina, alumina hydrate, zeolite, silica, colloidal silica and a mixture thereof. Preferably, the inorganic filler is silica, alumina, or calcium carbonate.

Advantageously, the inorganic filler have a particle size of 0.05 μm to 8 μm.

According to an embodiment of the invention, the water-based emulsion may be a vinyl acetate emulsion, an ethylene vinyl acetate emulsion, an acrylic emulsion, a silica acrylic emulsion, an urethane emulsion, a polyester emulsion, a chloroprene rubber latex, a butadiene latex, an isoprene rubber latex, an epoxy resin emulsion, a polyolefin emulsion, a fluorocarbon resin emulsion, or an acrylic silicone emulsion. Preferably, the water-based emulsion is a urethane emulsion. The water-based emulsion has an anchoring effect, and plays a role in the adhesion of the film to the substrate.

According to an embodiment of the invention, the ink receptor material comprises the inorganic filler and the water-based emulsion in a ratio of 1:0.1 to 1:50 by weight.

The ink receptor material according to the invention may optionally comprise a water-soluble polymer. The water soluble polymer, when is present, contribute to provide a good adhesion between the water-based emulsion and the inorganic filler and act as a protective colloid in the ink receptor. Preferably, the water soluble polymer contained in the ink receptor material is carboxymethyl cellulose, hydroxyethyl cellulose, methyl cellulose, polyvinyl alcohol, polyacrylic acid, polyacrylic acid metal salt, polyacrylamide, polyvinyl pyrrolidone, or polyethylene glycol. Preferably, the water soluble polymer is polyvinyl alcohol.

According to an embodiment of the invention, the ink receptor material comprises at least one inorganic filler, at least one water-based emulsion and at least one water soluble polymer in a ratio inorganic filler/water-based emulsion/water soluble polymer of 1/0.1 to 50/0 to 50 respectively.

In still another embodiment of the invention, the ink-receptor material may also comprise one or more carrier(s) able to accelerate the absorption of the ink into the substrate. According to an embodiment of the invention, carrier(s) included in the ink receptor material is (are) o-phenylphenol, chlorobenzene, methylsalicylate, dimethylterephthalate, butyl benzoate, benzyl alcohol, or phenethyl alcohol.

According to another embodiment of the invention, the ink receptor material may also comprise a modified cationic polymer, which helps preventing the migration and/or the clogging in the film, of the dispersed dye particles present in the ink receptor material. Preferably, the modified cationic polymer contained in the ink receptor material is obtained from the polymerisation or copolymerisation of the monomers having a quaternary ammonium side chain. The preferred monomers are a quaternary ammonium derivative of amino-alkyl-ester-acrylate or amino-alkyl-ester-methacrylate, a quaternary ammonium derivative of N,N-dimethylaminoethyl acrylate which is modified with methyl chloride or dimethyl sulfate. More preferred monomers are quaternary ammonium derivative of N-[3-(dimethylamino)propyl]acrylamide modified with methyl chloride, dimethyl sulfate, benzyl chloride or monochloroacetate, quaternary ammonium derivative of acrylamido-3-methyl-butyl-dimethylamine, and the monomer of vinyl-benzyl-ammonium salt or diallyl dimethyl ammonium salt having a quaternary ammonium side chain. Other preferred monomers are polyallylamine, polyethyleneimine, polyamine sulfone, polyamine-polyamide epichlorohydrin, copolymer of cationic polystyrene, cationic starch and vinyl monomer.

According to a particular embodiment of the invention, the ink receptor material comprises (a) an aqueous urethane resin, (b) a polyvinyl alcohol, (c) a modified cationic polymer, and (d) an inorganic filler. In this embodiment, advantageously, the proportions of each component on a solid basis are: (a) aqueous urethane resin: 10 to 50%; (b) polyvinyl alcohol: 0 to 60%; (c) modified cationic polymer: 0 to 30%; and the ratio of the amount of all polymers (a)-(c) and the inorganic filler is from 100:10 to 100:500 by weight.

According to another particular embodiment of the invention; the ink receptor material comprises (a) an aqueous urethane resin, (b) a polyvinyl alcohol, (c) a modified cationic polymer, (d) an inorganic filler, and (e) one or more carrier(s). In this embodiment, advantageously, the proportions of each component on a solid basis may be: (a) aqueous urethane resin: 10 to 50%; (b) polyvinyl alcohol: 0 to 60%; (c) modified cationic polymer: 0 to 30%; (d) the ratio of the amount of all polymers (a)-(c) and the inorganic filler is from 100:10 to 100:500 by weight; and (e) carrier(s): the proportion of carrier(s) to total components is from 0 to 3%.

The invention also relates to a method for tinting optical lenses, and more specifically to a method for tinting the substrates of lenses. In another embodiment the invention relates to a method for tinting optical lenses by tinting a primer coating applied onto the substrate of the lenses. The invention also relates to tinted lenses obtainable by the methods of the invention.

The method according to the invention is a method for tinting optical lenses, including:
1. coating the substrate of said optical lens with a layer of an ink receptor material capable to form a porous ink-receptor film;
2. evaporating solvents present in the ink receptor material, to form said porous film on said substrate;
3. applying an ink solution using an ink-jet machine on said porous film, in such conditions that the ink solution is absorbed within the film;
4. heating the said optical lens until the substrate has attained the desired tint; and
5. removing the ink receptor film.

The lenses, susceptible to be tinted according to the present invention are optical lenses that mean ophthalmic lenses, which have a substrate made of an organic glass commonly used for organic ophthalmic lenses.

In step 1, the coating can be performed by any method known by the skilled person, and preferably by a method selected from spin coating, dip coating and spraying. Advantageously, the ink receptor material comprises an inorganic filler and a water-based emulsion; more preferably, the ink receptor material is as herein described.

In step 2, the evaporation of solvents may be performed by any method known by the skilled person, but preferably comprises the following steps: (1) air-drying at room temperature; (2) heating at a temperature comprised from 40° C. to 100° C. for 0.5 min to 10 min.

According to an embodiment of the invention, the ink receptor film resulting from step 2 has a thickness of 0.1 μm to 50 μm, preferably of 2 μm to 25 μm, more preferably 5 μm.

In step 3, it is preferred that the distance between the substrate and the inkjet nozzle of the inkjet machine is from 0.5 mm to 5 mm, preferably from 1 mm to 2 mm. It is observed that the ink receptor material according to the invention is not dissolved into or by the solvent of the ink, contrary to the prior art water-soluble polymer coating.

According to the present invention, the term “ink” means any colored solution in which the color transferred into the substrate by heating; more preferably the ink solution according to the invention is a solution containing dispersed dyes. Preferably, the ink solution used in the invention is an aqueous solution containing dyes dispersed therein, said dyes being sublimated when heated at the appropriate temperature.

In step 4, the heating step allows the sublimation of the dyes contained in the ink and the transfer of the color into the substrate; the heating step includes applying a temperature of 90° C. to 240° C. during 10 seconds to 2 hours, preferably 120° C. to 180° C. during 30 min to 60 min, at normal pressure or under vacuum pressure. According to an embodiment of the invention, the heating step is carried at the pressure equal or less than 300 Pa, preferably equal or less than 100 Pa. The use of vacuum conditions allows the sublimation conditions of dyes to occur at a lower temperature than when normal pressure is used; disadvantages that may occur at high temperatures, for example deformation and yellowing of the substrate may thus be avoided.

The heating step is carried out in a heating device, for example air oven, far-infrared radiation oven, infrared oven, halogen lamp heater, autoclave and the like.

In step 5, according to an embodiment of the invention, the removal of the coating includes wiping it or washing it in presence of water, acid solution or basic solution and optionally may be combined with ultrasonic cleaning.

In another embodiment, the method according to the invention is a method for tinting optical lens comprising the following step:
1. coating the substrate of said optical lens with a transparent primer coating film;
2. drying the said primer coating;
3. coating the said primer coating of said optical lens with a layer of an ink receptor material capable to form a porous ink-receptor film;

4. evaporating solvents present in the ink receptor material, to form said porous ink-receptor film on said primer coating;
5. applying an ink solution using an ink-jet machine on said porous film, in such conditions that the ink solution is absorbed within the film;
6. heating the said optical lens until the said primer coating has attained the desired tint; and
7. removing the ink receptor film.

According to this embodiment, the transparent primer coating comprises: a self-emulsifiable emulsion of a linear polyurethane and/or water-compatible polyester resin; and metal oxide colloid particles which are fine particles of at least one is selected from aluminium oxide, iron oxide, tin oxide, zirconium oxide silica oxide, titanium oxide, tungsten oxide, antimony oxide, and their composite oxides. Advantageously, the metal colloid particles are modified by an organic silane compound of formula:

R(R₁)ₐSiX_{b}

wherein:
R represents a linear or branched (C₁-C₆)alkyl group which may be optionally substituted by a group selected from methacryloxy and glycidyloxy;
R₁ represents a linear or branched (C₁-C₆)alkyl group;
a is selected from 0, 1 and 2; and
b is selected from 1, 2, and 3, with the proviso that a+b=3.

The transparent primer coating has a film thickness comprised from 0.1 μm to 100 μm. This primer coating has the advantage to protect the substrate of the lens, which can be for example very sensitive to the abrasion like polycarbonate substrate.

The following examples refer to particular embodiments of the invention and shall not be interpreted as limiting the scope of this invention.

### EXAMPLES

### Example 1

### Preparation of Ink Receptor Materials

Preparation of Ink Receptor Material 1

We made an ink receptor by mixing the followings:

1. Inorganic Filer: 15 g of wet type silica powder “Finesil® X-30”, Average particle size=3 micron (Tokuyama Corporation)

2. Water-Dispersed Polyurethane: 100 g of “Superflex® 420”, Ester/ether type, (Dai-ichi kogyo seiyaku co., Ltd.)

3. 100 g of deionised water

4. 9 g of ethyl alcohol

5. 2 g of 1-methoxy-2-propanol

Preparation of Ink Receptor Material 2

We made an ink receptor by mixing the followings:

1. Inorganic Filer: 15 g of wet type silica powder “Finesil® X-30”, Average particle size=3 micron (Tokuyama Corporation)

2. Water-Dispersed Polyurethane: 100 g of “Bayhydrol® VPL82952” aliphatic type (Sumitomo Bayer)

3. 100 g of deionised water

4. 9 g of ethyl alcohol

5. 4 g of 1-methoxy-2-propanol

Preparation of Ink Receptor Material 3

We made an ink receptor by mixing the followings:

1. Inorganic Filer: 15 g of wet type silica powder “Finesil X-60”, Average particle size=6 micron (Tokuyama Corporation)

2. Water-Dispersed Polyurethane: 100 g of “Bayhydrol® VPL82952” aliphatic type (Sumitomo Bayer)

3. 100 g of deionised water

4. 9 g of ethyl alcohol

5. 4 g of 1-methoxy-2-propanol

Preparation of Ink Receptor Material 4

We made an ink receptor by mixing the followings:

1. Inorganic Filer: 15 g of wet type silica powder “Finesil® X-30”, Average particle size=3 micron (Tokuyama Corporation)

2. Water-Dispersed Polyester: 100 g of “VYLON® VYLONAL® MD1985 (TOYOBO)

3. 100 g of deionised water

4. 9 g of ethyl alcohol

5. 4 g of 1-methoxy-2-propanol

Preparation of Ink Receptor Material 5

We made an ink receptor by mixing the followings:

1. Inorganic Filer: 15 g of wet type silica powder “Finesil® X-30”, Average particle size=3 micron (Tokuyama Corporation)

2. Water-Dispersed Polyurethane: 100 g of “Superflex® 610”, Ester/ether type, (Dai-ichi kogyo seiyaku co., Ltd.)

3. Cationic Polymer: 10 g of UNISENCE FPA 100L (Senka)—polymer of DADMAC (Diallyl dimethyl ammoniumchloride)

4. 85 g of deionised water

5. 9 g of ethyl alcohol

6. 2 g of 1-methoxy-2-propanol

Preparation of Ink Receptor Material 6

We made an ink receptor by mixing the followings:

1. Inorganic Filer: 15 g of wet type silica powder “Finesil® X-30”, Average particle size-3 micron (Tokuyama Corporation)

2. Water-Dispersed Polyester: 100 g of “VYLON® VYLONAL® MD1985 (TOYOBO)

3. Carrier: 3 g of Benzyl alcohol

4. 100 g of deionised water

5. 9 g of ethyl alcohol

6. 4 g of 1-methoxy-2-propanol

Preparation of Ink Receptor Material “MZ-480” (Polyurethane+Silica Filler Ink Receptor; Maker: Takamatsu Oil and Fat)

According to the MSDS of MZ-480, the composition of the MZ-480 is:

| | |
|---|---|
| Mixture of polyvinylalcohol, polyurethane, | 20.6% |
| polycationic agent and silica | |
| N-Methyl-2-pyrrolidone | 1.1% |
| 1-Propanol | 1.3% |
| Water | 77.0% |

### Example 2

### Method of Tinting

1) The ink receptor liquids were coated on the concave sides of a substrate by a spin coating method;
2) The thus-coated lens was placed on a rubber O-ring which has the same diameter of the lens and covered with a stainless petri dish, air-dried at room temperature for 3 minutes and heat-treated at 80° C. for 5 minutes, whereby an ink receptor layer was formed on the substrate;
3) the lens is kept until it is at a room temperature;
4) the coated lens is placed on a height adjustable stage of an inkjet printer “GP-604” (Mimaki Engineering Corp.);
5) Four inkjet cartridges, which contain SPC-0370C (Cyan), SPC-0370M (Magenta), SPC-0370Y (Yellow) and SPC-0370K (black) are set on the inkjet printer;
6) A figure having the same diameter than the substrate with color is drawn with a drawing software, Adobe® Illustrator® and printed on the concave surface of the lens with the inkjet printer;
7) The lens was placed on the rubber O-ring and the ink dyes were sublimated at the conditions in below table:

TABLE 1
Condition of heat-treatment of the lens

| | Power | Diameter | | | | |
|---|---|---|---|---|---|---|
| Material | (dptr) | (mm) | Temperature | Pressure | | Time |
| CR-39 ® | −2.00 | 80 | 135° C. | 100 | Pascal | 30 min |
| MR-8 | +5.00 | 65 | 135° C. | 100 | Pascal | 30 min |
| HIE | −6.00 | 80 | 170° C. | Atmosphere | | 60 min |
| PC(HC) | +0.00 | 70 | 135° C. | 10 | Pascal | 30 min |

CR-39: PPG material: diethyleneglycol bis(allyl carbonate)
MR-8: Mitsui material based on polythiourethane polymer
HIE: Mitsui material based on episulfide polymer
PC(HC): Polycarbonate + primer coating

8) The lens was cooled down until it becomes at room temperature.
9) The residual on the lens surface was removed with ethyl alcohol.
10) The transmittance and cosmetic of the color lens was inspected and the results are shown in the tables below.

### Example 3

### Cosmetic and Visual Transmittance of the Colored Lenses

TABLE 3-1
substrate = CR-39 ®
Ink data of Adobe ® Illustrator ®: Cyan = 36;
Magenta = 20; Yellow = 24; Black = 32

| | Cosmetic (Color | | Thickness of ink |
|---|---|---|---|
| Ink receptor | uniformity) | Visual transmittance | receptor |
| 1 | Good | 29.4 | 6 |
| 2 | Very good | 28.5 | 5 |
| 3 | Good | 27.3 | 7 |
| 4 | Good | 26.1 | 6 |
| 5 | Good | 24.5 | 5 |
| 6 | Good | 29.1 | 6 |
| MZ-480 | Very good | 27.9 | 7 |

TABLE 3-2
Substrate = MR-8
Ink data of Adobe ® Illustrator ®: Cyan = 36;
Magenta = 20; Yellow = 24; Black = 32

| Ink receptor | Cosmetic (Color uniformity) | Visual transmittance |
|---|---|---|
| 1 | Good | 39.8 |
| 2 | Very good | 36.8 |
| 3 | Good | 40.7 |
| 4 | Good | 42.4 |
| 5 | Good | 34.5 |
| 6 | Good | 39.2 |
| MZ-480 | Very good | 41.2 |

TABLE 3-3
Substrate = HIE
Ink data of Adobe ® Illustrator ®: Cyan = 36;
Magenta = 20; Yellow = 24; Black = 32

| Ink receptor | Cosmetic (Color uniformity) | Visual transmittance |
|---|---|---|
| 1 | Good | 37.2 |
| 2 | Very good | 34.2 |
| 3 | Good | 33.2 |
| 4 | Good | 39.1 |
| 5 | Good | 36.3 |
| 6 | Good | 36.7 |
| MZ-480 | Very good | 38.2 |

TABLE 3-3
Substrate = PC(HC)
Ink data of Adobe ® Illustrator ®: Cyan = 36;
Magenta = 20; Yellow = 24; Black = 32

| Ink receptor | Cosmetic (Color uniformity) | Visual transmittance |
|---|---|---|
| 1 | Good | 37.2 |
| 2 | Good | 34.7 |
| 3 | Good | 33.2 |
| 4 | Very good | 39.1 |
| 5 | Good | 36.3 |
| 6 | Good | 37.6 |
| MZ-480 | Good | 34.2 |

1. Ink receptor material comprising an inorganic filler and a water-based emulsion.

2. Ink receptor material according to claim 1, wherein the inorganic filler is selected from light calcium carbonate, heavy calcium carbonate, kaolin, talc, titanium dioxide, zinc oxide, zinc carbonate, satin white, magnesium carbonate, magnesium silicate, magnesium sulphate, calcium silicate, aluminium silicate, aluminium hydroxide, alumina sol, colloidal alumina, alumina hydrate, zeolite, silica, colloidal silica, and a mixture thereof.

3. Ink receptor material according to claim 1, wherein the inorganic filler is selected from silica, alumina, and calcium carbonate.

4. Ink receptor material according to claim 1, wherein the inorganic filler have a particle size comprised of 0.05 μm to 8 μm inclusive.

5. Ink receptor material according to claim 1 wherein the water-based emulsion is selected from vinyl acetate emulsion, ethylene vinyl acetate emulsion, acrylic emulsion, silica acrylic emulsion, urethane emulsion, polyester emulsion, chloroprene rubber latex, butadiene latex, isoprene rubber latex, epoxy resin emulsion, a polyolefin emulsion, fluorocarbon resin emulsion, and acrylic silicone emulsion.

6. Ink receptor material according to claim 5, wherein the water-based emulsion is urethane emulsion.

7. Ink receptor material according to claim 1, comprising the inorganic filler and the water-based emulsion in a ratio of 1:0.1 to 1:50 by weight.

8. Ink receptor material according to claim 1, further comprising a water-soluble polymer.

9. Ink receptor material according to claim 8, wherein the water-soluble polymer is selected from carboxymethyl cellulose, hydroxyethyl cellulose, methyl cellulose, polyvinyl alcohol, polyacrylic acid, polyacrylic acid metal salt, polyacrylamide, polyvinyl pyrrolidone, and polyethylene glycol.

10. Ink receptor material according to claim 9, wherein the water soluble polymer is polyvinyl alcohol.

11. Ink receptor material according to claim 1, comprising at least one inorganic filler, at least one water-based emulsion and at least one water soluble polymer in a ratio inorganic filler/water-based emulsion/water soluble polymer of 1/0.1 to 50/0 to 50 respectively.

12. Ink receptor material according to claim 1, further comprising one or more carrier(s) able to accelerate the absorption of the ink into the substrate.

13. Ink receptor material according to claim 12, wherein the carrier(s), included in the ink receptor material is (are) selected from o-phenylphenol, chlorobenzene, methylsalicylate, dimethylterephthalate, butyl benzoate, benzyl alcohol, and phenethyl alcohol.

14. Ink receptor material according to claim 1, further comprising a modified cationic polymer, said modified cationic polymer being obtained from the polymerisation or copolymerisation of monomers having a quaternary ammonium side chain.

15. Ink receptor material according to claim 1, comprising (a) an aqueous urethane resin, (b) a polyvinyl alcohol, (c) a modified cationic polymer, and (d) an inorganic filler.

16. Ink receptor material according to claim 15, wherein the proportions of each component on a solid basis are: (a) aqueous urethane resin: 10% to 50%; (b) polyvinyl alcohol: 0% to 60%; (c) modified cationic polymer: 0% to 30%; and the ratio of the amount of all polymers (a)-(c) and the inorganic filler is from 100:10 to 100:500 by weight.

17. Ink receptor material according to claim 1, comprising (a) an aqueous urethane resin, (b) a polyvinyl alcohol, (c) a modified cationic polymer, (d) an inorganic filler, and (e) one or more carrier(s).

18. Ink receptor material according to claim 17, wherein the proportions of each component on a solid basis is:
(a) aqueous urethane resin: 10 to 50%;
(b) polyvinyl alcohol: 0 to 60%;
(c) modified cationic polymer: 0 to 30%;
(d) inorganic filler: the ratio of the amount of all polymers (a)-(c) and the inorganic filler is from 100:10 to 100:500 by weight; and
(e) carrier(s): the proportion of carrier(s) to total components is from 0 to 3%.

19. Method for tinting optical lens, including coating the substrate of said optical lens with a layer of an ink receptor material capable to form a porous ink-receptor film; evaporating solvents present in the ink receptor material, to form said porous ink-receptor film on said substrate; applying an ink solution using an ink-jet machine on said porous film, in such conditions that the ink solution is absorbed within the film; heating the said optical lens until the substrate has attained the desired tint; and removing the ink receptor film.

20. (canceled)

21. Method according to claim 19, wherein the ink receptor material comprises an inorganic filler and a water-based emulsion.

22. Method according to claim 19, wherein the coating is performed by a method selected from spin coating, dip coating, and spraying.

23. Method according to claim 19 wherein the evaporation of solvents includes a first air-drying step at room temperature; following by heating step at a temperature comprised from 40° C. to 100° C. for 0.5 min to 10 min.

24. Method according to claim 19 wherein the ink receptor film formed onto the substrate has a thickness comprised from 0.1 μm to 50 μm.

25. Method according to claim 24 wherein the ink receptor film formed onto the substrate has a thickness comprised from 2 μm to 25 μm.

26. Method according to claim 24 wherein the ink receptor film formed onto the substrate has a thickness of 5 μm.

27. Method according to claim 19, wherein the distance between the substrate surface and the inkjet nozzle of the inkjet machine is comprised from 0.5 mm to 5.0 mm.

28. Method according to claim 27, wherein the distance between the substrate surface and the inkjet nozzle of the inkjet machine is comprised from 1 mm to 2 mm.

29. Method according to claim 19, wherein the heating step is carried out at normal pressure or under vacuum pressure conditions.

30. Method according to claim 29, wherein the pressure is inferior to 300 Pa.

31. Method according to claim 29, wherein the pressure is inferior to 100 Pa.

32. Method according to claim 29, wherein the heating step is carried out at a temperature comprised from 90° C. to 240° C. for a time comprised from 10 seconds to 2 hours.

33. Method according to claim 32, wherein the heating step is carried out at a temperature comprised from 120° C. to 180° C. during 30 min to 60 min included.

34. Method according to claim 19 wherein the removal of the ink-receptor film is done by wiping it or by washing it with a solution selected from water, acid solution, and basic solution, said washing may be optionally combined with ultrasonic cleaning.

35. Method according to claim 19 comprising the following steps of:
(a) coating the substrate of said optical lens with a transparent primer coating film;
(b) drying the said primer coating;
(c) coating the said primer coating of said optical lens with a layer of an ink receptor material capable to form a porous ink-receptor film;
(d) evaporating solvents present in the ink receptor material, to form said porous ink-receptor film on said primer coating;
(e) applying an ink solution using an inkjet machine on said porous film, in such conditions that the ink solution is absorbed within the film;
(f) heating the said optical lens until the said primer coating has attained the desired tint; and
(g) removing the ink receptor film.

36. Method according to claim 35 wherein the transparent primer coating comprises: a self-emulsifiable emulsion of a linear polyurethane and/or water-compatible polyester resin; and metal oxide colloid particles which are fine particles of at least one is selected from aluminium oxide, iron oxide, tin oxide, zirconium oxide silica oxide, titanium oxide, tungsten oxide, antimony oxide, and their composite oxides.

37. Method according to claim 36 wherein the metal colloid particles are modified by an organic silane compound of formula: R(R₁)ₐSiX_{b} wherein:
R represents a linear or branched (Q-C₆)alkyl group which may be optionally substituted by a group selected from methacryloxy and glycidyloxy;
R₁ represents a linear or branched (C₁-C₆)alkyl group;
a is selected from 0, 1 and 2; and—b is selected from 1, 2, and 3, with the proviso that a+b=3.

38. Method according to claim 35 wherein the transparent primer coating has a film thickness comprised from 0.1 μm to 100 μm.

39. Tinted optical lens obtained by using the method of tinting according to claim 19.
